(19) United States
(12) Patent Application Publication
(10) Pub. No.: US 2025/0362705 A1
(43) Pub. Date: Nov. 27, 2025

(54) OPTICAL PROCESSING SYSTEMS AND METHODS WITH FEEDBACK LOOP

(71) Applicant: Optalysys Limited, Leeds (GB)

(72) Inventors: Iman KUNDU, Castleford (GB); Florent MICHEL, Castleford (GB); Alan BELL, Leeds (GB)

(21) Appl. No.: 18/044,699

(22) PCT Filed: Sep. 10, 2021
(86) PCT No.: PCT/GB2021/052359

§ 371 Date: Mar. 9, 2023

(30) Foreign Application Priority Data
Sep. 10, 2020 (GB) 2014282.4

(51) Int. Cl. G06E 3/00

(52) U.S. Cl. CPC G06E 3/005

(57) ABSTRACT

An optical processing system comprises an Optical Fourier transform stage; and one or more photodetectors for receiving a reference optical signal to provide currents and/or voltages relating to the intensities and/or phases of the reference optical signal; the system further comprising an electronics feedback loop which feeds back the currents and/or voltages and modulates the intensities and/or phases of a subsequent optical signal.

### TECHNICAL FIELD

Certain embodiments of the invention pertain to the field of optical processing system, methods of optical processing and methods of calibration.

### BACKGROUND AND PRIOR ART KNOWN TO THE APPLICANT

The closest prior art may be found in the Applicant's own prior published patent applications. The following are provided by way of example only:
EP1420322;
WO2018167316;
EP1546838;
U.S. Ser. No. 10/289,151;
U.S. Ser. No. 10/409,084;
WO2019207317;
PCT/EP2020/065740.

The multiplication of optical fields poses a challenge particularly in the fields of optical computing and cryptography. Optical fields are composed of an amplitude component and a phase component and both must be treated correctly in the multiplication. Previous techniques of optical multiplication involve non-linear optical materials, requiring high intensity light. For low power applications, amplitude and phase modulation is achieved by capturing the information with an Analog-Digital-Converter (ADC) and carrying out the multiplication in a microprocessor.

### SUMMARY OF THE INVENTION

In a broad independent aspect, the invention provides an optical processing system comprising an optical input; an optical Fourier transform stage; one or more modulators provided between said optical input and said optical Fourier transform stage; and said optical Fourier transform stage providing an optical output to one or more photodetectors for receiving a reference optical signal to provide currents and/or voltages relating to the intensities and/or phases of the reference optical signal; said system further comprising an electronics feedback loop which feeds back the currents and/or voltages and causes said modulators to modulate the intensities and/or phases of a subsequent optical signal.

This is particularly advantageous as it allows the modulation to be, in certain embodiments driven via an electronics feedback loop in order to achieve multiplication, convolutions and product of sequences via an optical stage. This approach significantly overcomes the latency problems associated with prior art electronic microprocessor-based system.

In a subsidiary aspect, the optical Fourier transform stage is a single Optical Fourier transform stage. This is particularly beneficial over prior art optical processing systems which require much more complex optical stages which would often be 4 f optical stages.

In a further subsidiary aspect, at least one of the modulators comprises an interferometer with a first branch for optically encoding a signed Real value and with a second branch for optically encoding a signed Imaginary value. Due to, in certain embodiments, the orthogonality of the phase of the real and imaginary axes, the signed real and imaginary numbers can advantageously propagate through the transmission media simultaneously without any loss of information.

In a further subsidiary aspect, the interferometer encodes a signed magnitude and a signed orthogonal or quadrature phases on the optical signal.

In a further subsidiary aspect, the system further comprises as part of said electronics feedback loop an analogue circuit configured to carry out a mathematical function on currents from the photodetectors to provide an output of currents and/or voltages which is proportional to the phase of the reference optical signal.

In a further subsidiary aspect, the analogue circuit comprises one or more pairs of photodetectors.

In a further subsidiary aspect, the electronics feedback loop comprises one or more drivers for intensity and/or phase modulation.

In a further subsidiary aspect, the analogue circuit comprises a rectifier circuit which drives intensity modulation.

In a further subsidiary aspect, the analogue circuit comprises a comparator to compare the difference signal with a predetermined voltage reference.

In a further subsidiary aspect, the comparator has an output and the analogue circuit takes the comparator output and adds another predetermined voltage; whereby a phase shift is generated for phase shifting modulation.

In a further subsidiary aspect, the optical processing system comprises one or more pairs of photodetectors, one or more analogue to digital converters, a microprocessor with either a pre-calibrated look-up-table to retrieve digital values or a digital signal processor (DSP), and one or more digital to analogue converters which generate the voltages and/or currents for driving intensity and/or phase modulators which modulate the intensities and/or phases of the optical signal.

In a further broad independent aspect, the invention provides a method of optical processing comprising the steps of providing an optical input, providing an optical Fourier transform stage; providing one or more modulators between said optical input and said optical Fourier transform stage; and said optical Fourier transform stage providing an optical output to one or more photodetectors for receiving a reference optical signal to provide currents and/or voltages relating to the intensities and/or phases of the reference optical signal; providing an electronics feedback loop; feeding back the currents and/or voltages; and modulating the intensities and/or phases of a subsequent optical signal.

In a subsidiary aspect, the Optical Fourier transform stage is a single Optical Fourier transform stage.

In a further subsidiary aspect, the method further comprises the step of optically encoding a signed Real value and a signed Imaginary value into the properties of the optical signal.

In a further subsidiary aspect, the method further comprises the steps of encoding a signed magnitude and a signed orthogonal or quadrature phases on the optical signal.

In a further subsidiary aspect, the method further comprises the step of providing, as part of said electronics feedback loop, an analogue circuit; and carrying out a mathematical function on currents from the photodetectors to provide an output of currents and/or voltages which is proportional to the phase of the reference optical signal.

In a further subsidiary aspect, the analogue circuit comprises one or more pairs of photodetectors.

In a further subsidiary aspect, the electronics feedback loop comprises one or more drivers for intensity and/or phase modulation.

In a further subsidiary aspect, the analogue circuit comprises a rectifier circuit which drives intensity modulation.

In a further subsidiary aspect, the analogue circuit comprises a comparator; and the method comprises the further step of comparing the difference signal with a predetermined voltage reference.

In a further subsidiary aspect, the comparator has an output and the method comprises the steps of taking the comparator output and adding another predetermined voltage; whereby a phase shift is generated for phase shifting modulation.

In a further subsidiary aspect, the method comprises the steps of providing one or more pairs of photodetectors, providing a microprocessor, providing one or more analogue to digital converters, providing either a pre-calibrated look-up-table or a digital signal processor (DSP) to retrieve digital values, and providing one or more digital to analogue converters which generate the voltages and/or currents for driving intensity and/or phase modulators which modulate the intensities and/or phases of the optical signal.

In a further broad independent aspect, the invention provides a method of calibrating an optical processing system comprising the steps of:
providing an input plane with a plurality of independently tuneable pixels; and an optical system for producing an Optical Fourier transform in an output plane;
measuring the light intensity at different pixels of the output plane;
selecting a first pixel of the output plane; and
comparing the intensity of a further pixel a with that obtained with the first pixel.

In a subsidiary aspect, the method comprises the further steps of:
selecting level 1 and level 2 as predetermined fixed levels;
selecting said pixel a and a further pixel b;
measuring a value of said output corresponding to said first pixel in at least the following modes: with pixel a at level 1 and all other input pixels at level 2; with pixel b at level 1 and all other input pixels at level 2; and with pixels a and b at level 1 and all other input pixels at level 2; and
estimating a phase difference between said pixels a and b in their level 1 state.

In a further subsidiary aspect, the first pixel corresponds to an arbitrary pixel in the input function.

In a further subsidiary aspect, the first pixel corresponds to the central pixel in the input function.

In a further subsidiary aspect, the method comprises the further step of measuring the phase differences of a and b with a further pixel.

In a further broad independent aspect, the invention provides a method of calibrating an optical processing system comprising the steps of providing an input plane with a plurality of independently tuneable pixels; and an optical system for producing an Optical Fourier transform in an output plane; measuring the light intensity at different pixels of the output plane; and comparing an output with theoretical predictions and minimizing the distance between them over predetermined input parameters.

In a subsidiary aspect, the step of minimizing is performed by successively setting the input parameters to each of their possible values, recording the corresponding outputs, then computing the distance for each value and selecting the one giving the minimum distance.

In a further subsidiary aspect, the method further comprises the step of computing the distance on an external electronic computing device.

In a further subsidiary aspect, the method further comprises the step of successively performing calibration on each of the input pixels after the choice of a reference pixel.

In a further subsidiary aspect, the distance is defined by taking the squared absolute value of the output from the optical system and computing the Euclidean distance from the theoretical prediction after dividing each of them by their maximum value.

In a further subsidiary aspect, the method comprises a minimisation process which proceeds as follows:
selecting an input pixel r to serve as reference;
finding parameters for which r has a relatively high value;
for at least one other pixel p, selecting a desired phase difference φ and relative modulus a with said reference pixel;
selecting values, denoted by v of the parameters for pixel p;
setting all input pixels to 0 except r and p;
storing the resulting output image, called O(v) hereafter;
computing the squared absolute value of the discrete Fourier transform of the input obtained by setting all the pixels to 0 except the reference pixel, with value 1, and pixel p, with value given by the formula a exp(i φ);
storing the result, called T; and
finding the values v of the parameters for which the distance between O(v) and T is smallest.

### BRIEF DESCRIPTION OF THE FIGURES

FIG. 1 shows a method of phase multiplication which involves the addition of two phases. This may be achieved by applying two separate phase shifts in series.

FIG. 2 schematically shows how phase multiplication can be achieved by applying a signal to a single phase modulator, determined electronically by summing the desired phase shift voltages or currents.

FIG. 3 shows schematically how optical multiplication would be achieved by modulating the first signal Frame 1, measuring the phase and intensity, digitising the result and passing it to a CPU to be held in memory. A second signal, Frame 2 would follow and the two digital values would be multiplied in an ALU.

FIG. 4 shows a method of electro-optically multiplying two optical signals. (Top) Signals in Frame 1 are modulated on to the light. The light is detected and decoded to obtain intensity and phase. A driver circuit determines the voltages necessary to feed back to the optical circuit. (Bottom), when Frame 2 arrives, the feedback trigger allows the modulator values held by the driver circuit to drive the modulators. Frame 2 passes through the 2nd modulator adding the phases of Frames 1 and 2.

FIG. 5 shows a two-pass system in which the Reference Oscillator Phase Shifter (ROPS) induces no phase shift in the first path, and a quadrature (pi/2) phase shift in the second pass. The four signals from the two photo-detectors are processed to generate voltages or currents that induce the same, or related optical intensity and phase on to the next incoming optical signal.

FIG. 6 shows a one-pass system in which the RO is split in to a zero-phase path and a quadrature path (pi/2) with the four photo-detector signals being obtained simultaneously. These signals are processed to provide voltages or currents that induce the same, or related optical intensity and phase on to the next incoming optical signal.

FIG. 7 shows In-phase (I) and Quadrature phase (Q) signals produced by taking the difference in PDn and PDm photodetector currents when the optical signal phase is swept from 0 to 2pi. The analog circuitry generates a linear response with a transfer function as shown in the examples, V=tan⁻¹(Q/I) or V=sgn(sin(Q/I){square root over ((1+cos(Q/I))}, where Q and I are the difference currents from the PDs.

FIG. 8 shows an example SPICE simulation circuit to generate the V_{d}=tan⁻¹(Q/I) approximation transfer function.

FIG. 9 shows one branch of the Mach-Zehnder Interferometer optically which encodes a signed Real value (In-Phase) whilst the other optically encodes a signed Imaginary value.

FIG. 10 shows the MZI branches which encode a signed magnitude and signed, orthogonal, or quadrature phases on the incoming light.

FIG. 11 shows a block diagram of an opto-electronic feedback system.

FIG. 12 shows a block diagram of an analog circuit to perform a Cartesian addressing method.

FIG. 13 shows a block diagram of a digital circuit to perform the Cartesian addressing method.

FIG. 14 shows a flow diagram of the phase difference estimation.

FIG. 15 shows example images from the phase difference estimation method where (a) shows an input image with a reference and arbitrarily chosen pixels set to level 2 (illuminated); (b) a simulation showing the expected output; and (c) the measure output from the interference of the two pixels at the Fourier Plane.

FIG. 16 shows a flow diagram of the parameter value estimation method.

### DETAILED DESCRIPTION OF THE FIGURES

Certain embodiments of this invention make low-power optical multiplication achievable by electronically measuring the optical field (intensity and phase) then deriving voltages or currents necessary to induce the same properties onto intensity and phase modulators positioned upstream. A following optical signal is then passed through the system, undergoing an intensity and phase multiplication with the properties of the previous input. The feedback signals can be held constant so that multiple subsequent optical signals can be multiplied by the same constant, or they can vary with each frame N, multiplying each by frame N−1.

Coherent optical signals can carry information in the form of intensity and/or phase. A single wavelength light signal can be mathematically represented as a phasor with the equation:

$$E = A \cdot {exp}^{i θ t}$$

where A is the amplitude of the light, equal to the square root of intensity (I) \sqrt{I}, and θ is the phase, relative to some chosen reference.

Optical multiplication is the processes of taking two coherent light sources and multiplying the phasors to obtain;

$${E}_{1} \times {E}_{2} = {A}_{1} \cdot {exp}^{i {θ}_{1} t} \times {A}_{2} \cdot {exp}^{i {θ}_{2} t} = {A}_{1} \cdot {A}_{2} \cdot {exp}^{i ( {θ}_{1} + {θ}_{2} ) t}$$

The normalised amplitude components multiply while the phase components add. To carry out the amplitude multiplication, the intensity of E₁ and E₂ is measured and used to determine the combined amplitude by;

$${A}_{1} \cdot {A}_{2} ∝ \sqrt{{I}_{1}^{2} + {I}_{2}^{2}}$$

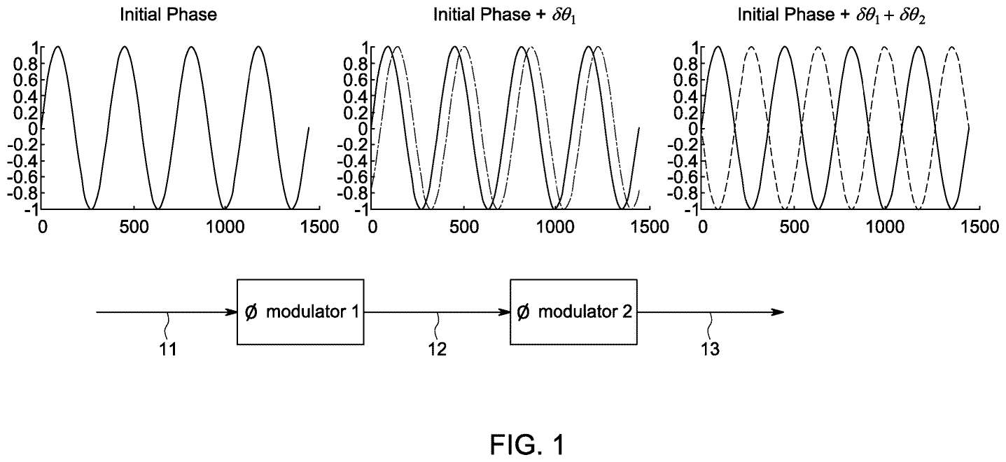

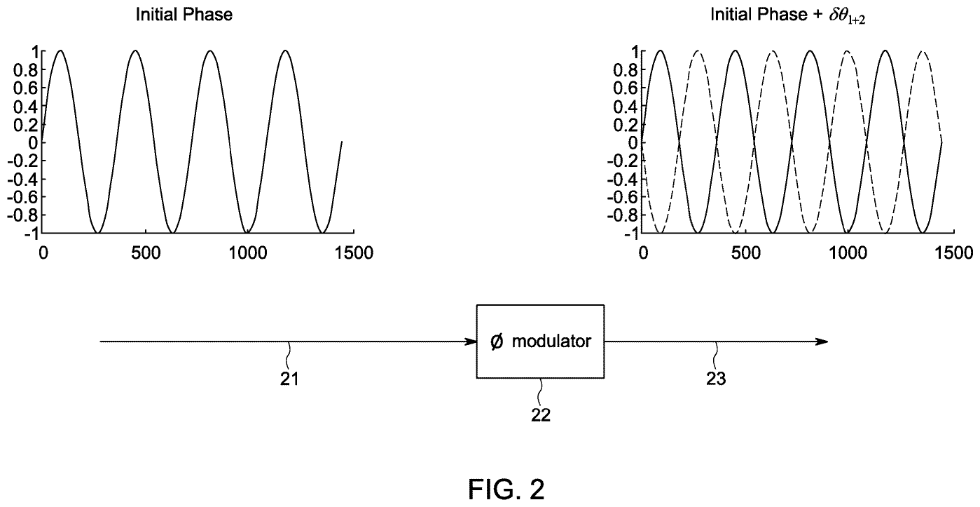

Although measurement of the phase is more complicated than measuring the intensity, the result can be recreated by a simple addition, either by applying two optical phase shifts in series (FIG. 1) or applying a summed drive signal to a single phase shifter (FIG. 2). In FIG. 1, the light enters at 11 with zero phase. A phase modulator induces a desired phase δθ₁ at 12. A second phase modulator induces the remaining phase of δθ₂ resulting in a total phase shift of δθ₁+δθ₂ at 13. This allows greater modulation depth. In FIG. 2, the light enters with zero phase at 21. A single phase modulator at 22 induces the entire desired phase δθ₁₊₂ seen at 23. This simplifies the drive electronics.

Certain preferred embodiments provide a method in which the multiplication can be achieved electro-optically, using electronic measurements or pre-calculated values of the intensity and phase to feed back into optical circuitry to perform the multiplication optically.

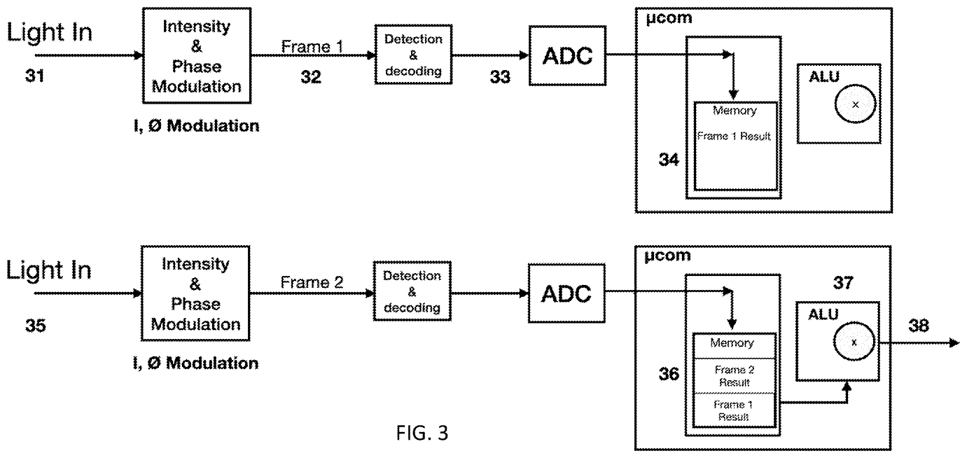

The ‘typical’ way this would be achieved is as follows. Referring to FIG. 3, the light signal enters an optical circuit at 31 and undergoes some amplitude and phase modulation at 32. The resultant light is detected by photodetectors, amplified and decoded to obtain the intensity and phase at 33, represented by analog voltages. These analog voltages would be digitised by an ADC at 33 and held in memory at 34.

A second light signal enters the same point in the system at 35, producing a second set of amplitude and phase values. The resulting intensity and phase values are held in memory (36). Using a CPU, or ALU (37), the digital values of the form A₁+iθ₁ and A₂+iθ₂ would be multiplied to give;

$$( {A}_{1} + i {θ}_{1} ) ( {A}_{2} + i {θ}_{2} ) = {A}_{1} {A}_{2} + {A}_{1} i {θ}_{2} + A 2 i {θ}_{1} + {i}^{2} {θ}_{1} {θ}_{2} {\underbrace{= {A}_{1} {A}_{2} - {θ}_{1} {θ}_{2}}}_{ℛ} + i {\underbrace{( {A}_{1} {θ}_{2} + {A}_{2} {θ}_{1} )}}_{𝒥}$$

The real component, [symbol] represents the multiplication of the amplitudes, and the imaginary components, [symbol] represent the multiplication of the phase components. The result is passed to a PC for processing (38).

If the information is passed in as multiple pixels and many frames, this calculation would have to be done for every pixel and for every frame, incurring significant latency for high resolution data.

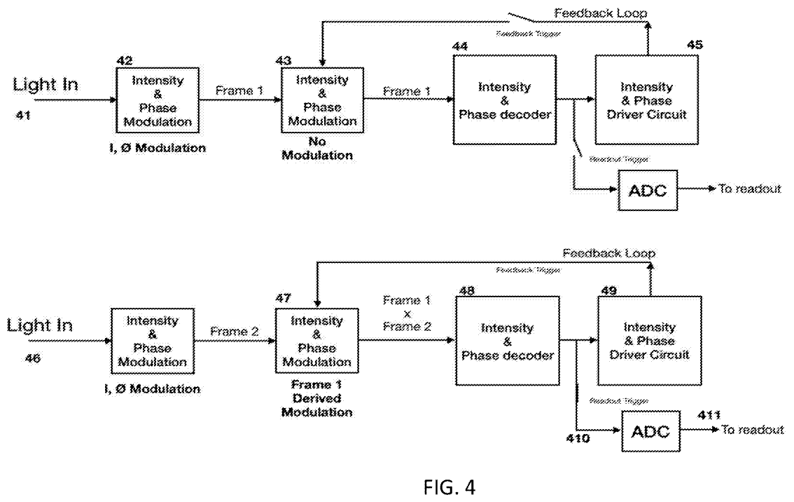

In certain embodiments described in the following sections, this multiplication process is taken out of the ALU and carried out naturally in photonics circuitry. FIG. 4 demonstrates the process. The light enters the photonics at 41 and is modulated by the intensity and phase modulators (42). Modulators at 43 do not induce any modulation on the first pass. The result is measured by photodetectors and decoded (44) to obtain intensity and phase information. Instead of being digitized and held in memory, the information can be either transferred through fast circuitry to a sample/hold circuit, or digitized and processed by means of a look-up table at (45), to obtain voltage or current values with which to drive optical modulators. These drive signals are then sent to the photonics circuit ready for the next ‘frame’ of information to enter the system. This subsequent light signal follows the same path, entering at 46. However this time, there is an additional intensity and phase modulation at 47 with the values derived from the previous pass. The act of passing through this set of modulators naturally carries out the optical multiplication. The resultant light is readout and decoded as before (48), passed to the intensity drive circuit (49), in the case of the requirement of a subsequent multiplication, or digitized by an ADC (410) for processing by a CPU or other microprocessor (411).

Certain embodiments described in the following, provide a method of inducing a desired phase and/or intensity modulation in a photonics pathway, determined by the intensity and/or phase of a previously recorded measurement or calculation, by the use of a fast electronics feedback loop. The act of inducing a calculated optical intensity and/or phase change on to a subsequent optical signal causes an optical multiplication of those signals, as described in Equation 1.

$${E}_{1} \times {E}_{2} = {A}_{1} {e}^{i {θ}_{1}} \times {A}_{2} {e}^{i {θ}_{2}} = {A}_{1} {A}_{2} {e}^{i {θ}_{1} + {θ}_{2}} \qquad Equation 1$$

Here, E₁ and E₂ are two optical fields with Amplitude A₁ and A₂, and phase θ₁ and θ₂ respectively.

The ability to record and feedback the intensity and phase information to modulate a subsequent input, is useful in calculating convolutions by performing an optical multiplication in Fourier Space as described in Equation 2.

$$\{ x ⊗ y \} = {ℱ}^{- 1} \{ X \cdot Y \} . \qquad Equation 2$$

where a Fourier Transformed optical signal X can be optically multiplied with the intensity and phase information in Y instantaneously and with very little power consumption.

Certain embodiments provide optical processing systems which detect the intensity of, and relative phase between, an intensity and phase encoded optical signal (S), or multiple signals, and a reference optical signal (RO) by means of a pair, or two pairs of photo-detectors (PDs). The currents or voltages generated or conducted by the PDs, by either photovoltaic mode or photoconductive mode operation, are amplified and processed by digital or analog electronics circuitry, and generate voltages (V_{d}) or currents (I_{d}) related to the intensity or relative phase or phases of the reference (RO) and information signal or signals (S). The RO can be the same wavelength as the optical signal (homodyne) or have a wavelength that is offset from the wavelength of the optical signal (heterodyne). The voltages (V_{d}) or currents (I) are then used to drive one or more optical intensity modulators and/or phase shifters to induce changes in phase and intensity, phase only, or intensity only, of a subsequent optical signal, identical to, or with some mathematical relationship to the previously measured or calculated intensity and phase. The phase shifters can be inline with the optical information signal, or part of an optical modulator, such as an interferometer which may be a Mach-Zehnder Interferometer (MZI). The phase shifters can be thermal phase shifters, carrier injection phase shifters, carrier depletion phase shifters, ring modulators or a combination of intensity only and phase only modulators, with the digital or analog circuitry transfer functions being adaptable for each intensity modulator and phase shifter method.

### Polar Coordinate Method

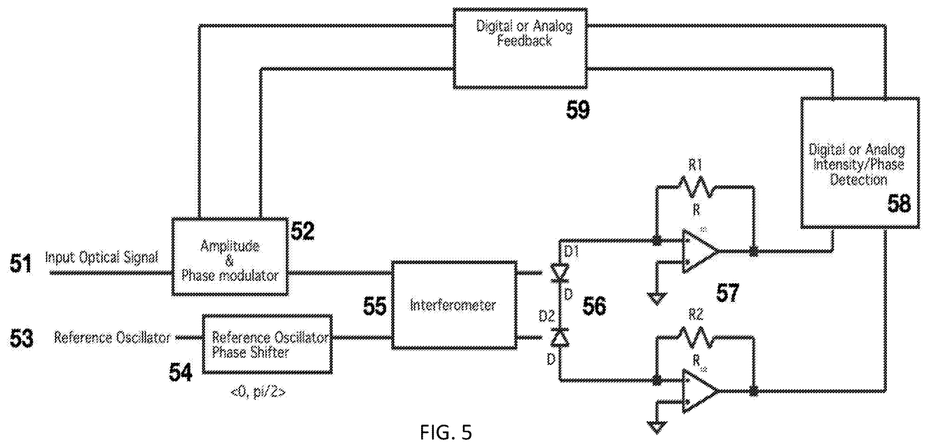

In the Polar Coordinate method, the relative phase is measured by an analog or high resolution digital circuit carrying out a mathematical function on the photodetector currents to provide a pair of output voltages or currents proportional to the phase ϕ. Referring to FIG. 5, the light enters at 51 and passes through the Amplitude and Phase modulator at 52. Simultaneously, a reference optical signal with phase=0 radians, enters at 53. The reference oscillator phase shifter (54) is passive (no phase induction) on the first pass, then induces a π/2 phase shift on the second pass. On each pass the optical information signal and reference oscillator signal enter a multi-mode interferometer (MMI) at 55. The two outputs of the MMI illuminate a balanced photo-detector consisting of two photodiodes (56) giving rise to two photo currents. The sum of the currents is related to the total intensity of the input signal at 55. The imbalance of the currents is related to the relative phase between the signal arriving at 55. After amplification 57 the signals are passed to an analog or digital intensity and phase decoding circuit 58 which samples and holds the values from each pass and uses them to generate voltages or currents at 59 necessary to drive the intensity and phase modulator at 52.

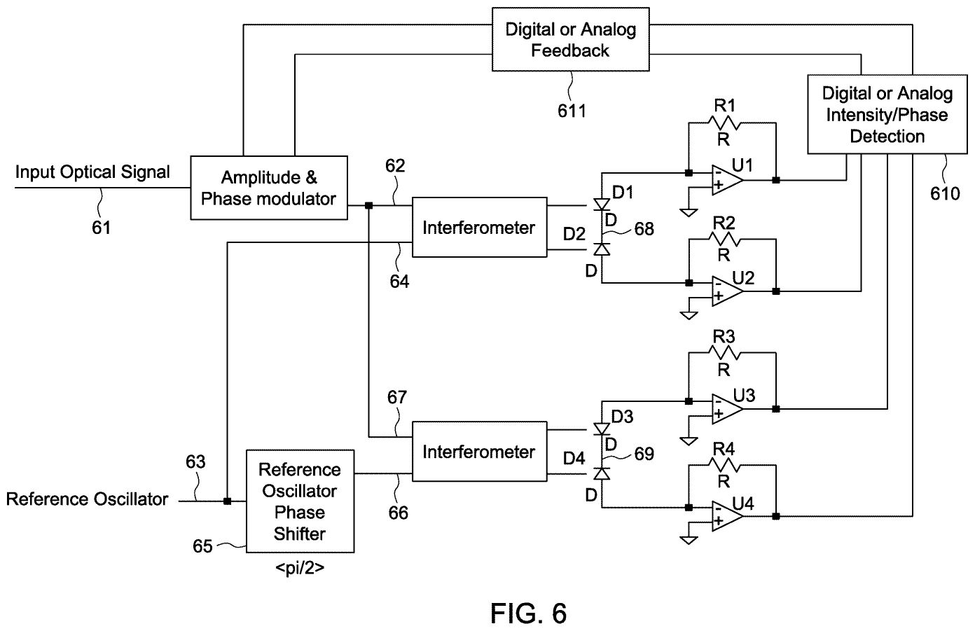

A similar method which avoids the need for two passes of the information is shown in FIG. 6. Light enters at 61 and passes through the amplitude and phase modulators at 62. The reference oscillator light signal enters at 63 which is split off to a MMI at 64, and a fixed π/2 phase delay at 65, the output of which goes to a second MMI at 66. The two MMIs interfere the information signal with the 0 phase and π/2 phase reference signal. The first is detected by balanced photo-detectors at 68, the second is detected by balanced photo-detectors at 69. The four photocurrents from the photodetectors go to an analog or digital intensity and phase detection circuit (610) which generates voltages or currents to feed back to the Amplitude & Phase modulator via the feedback block at 611.

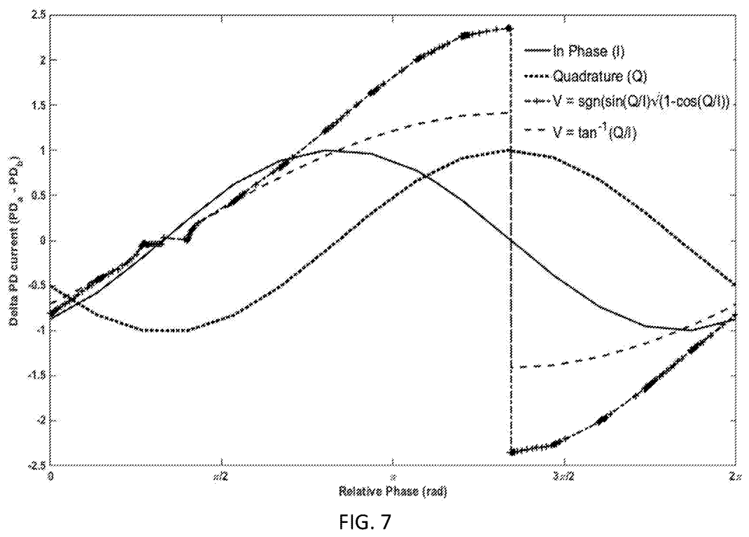

FIG. 7 shows the signals from the combined PDs, with the in-phase signal derived from the difference in currents of the two PDs when the RO is at zero phase, and the quadrature signal derived from the difference in currents from two PDs when the RO phase is shifted by π/2, either by dynamic modulation of the Reference Oscillator Phase Shifter shown in FIG. 5, or by a fixed phase shift induced by a path length or path refractive index difference as shown in FIG. 6. In any of the preceding or subsequent embodiments, further embodiments are envisaged in which the phase may be changed by either modifying the path length or the refractive index or a combination of both the path length and refractive index.

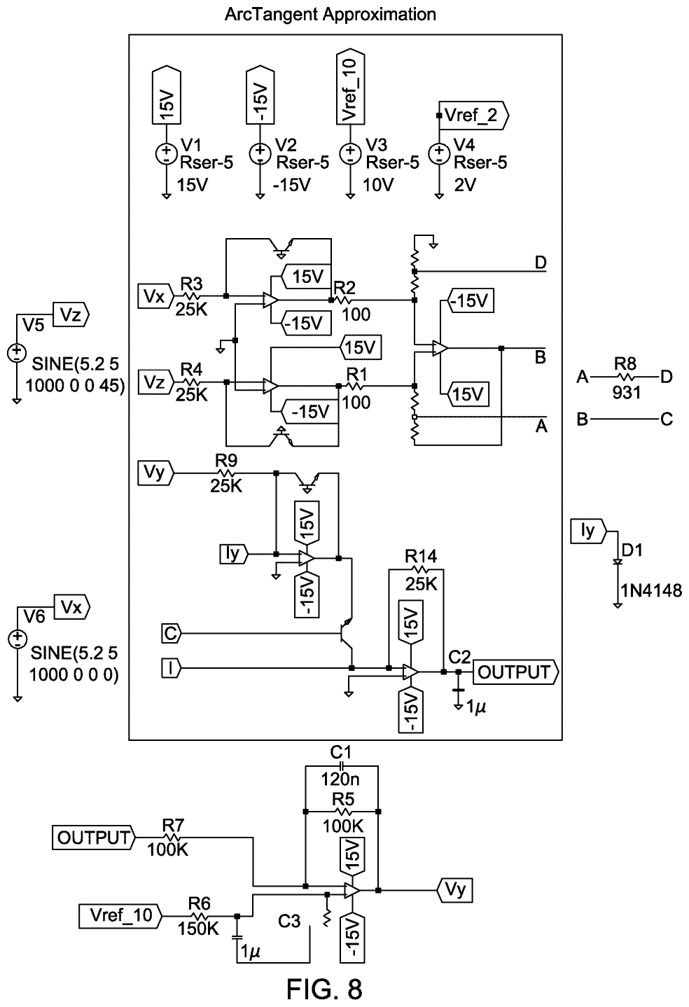

FIG. 7 shows two possible output transfer functions to drive a near-linear responsive device such as a thermal phase shifter. The analog circuitry (FIG. 8) generates a voltage proportional to the V(I, Q)=tan⁻¹(Q/I), which can be manipulated by amplification, DC level shifting and/or signal inverting as required. A second transfer function example is the function:

$$V ( I , Q ) = sgn ( sin ( Q / I ) \sqrt{1 + cos ( Q / I )}$$

which increases the linear range of the analog drive circuitry.

### Cartesian Addressing Method

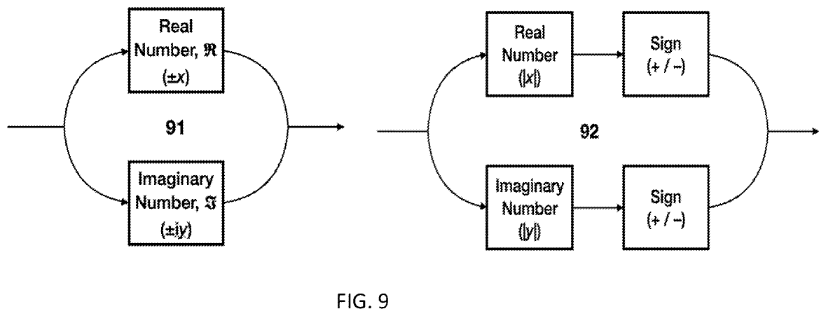

A further method, referred to as the Cartesian addressing method, uses an intensity only modulator and a phase shifting modulator, such as thermal, carrier depletion, carrier injection modulators or ring modulators (FIG. 9). The two branches of the Mach-Zehnder Interferometer (MZI) (91 or 92) encode the signed Real component and signed Imaginary component of the incoming light by applying a voltage or current to a pair of electro-optical absorbers and phase shifters.

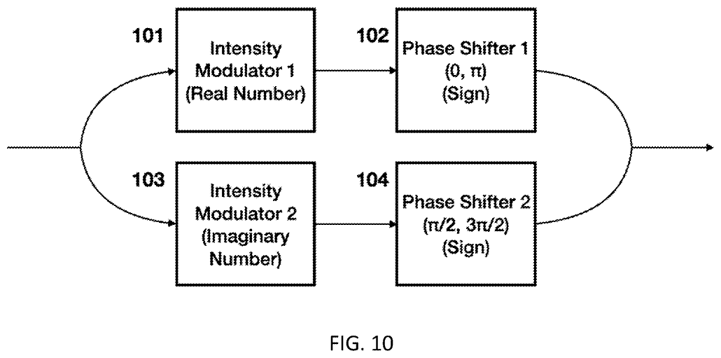

The phase shifters are each modulated with two possible values. For example, see FIG. 10. In the Real (Intensity) branch (101), the phase shifter (102) can be modulated to provide either a 0 radian phase shift, or a π phase shift. In the Imaginary branch(Phase) (103), the phase shifter (104) can be encoded to provide a π/2 radian phase shift, or a 3π/2 phase shift. The choices in phase shifts is arbitrary, with the only requirement being that one branch encodes an orthogonal, or quadrature phase shift to the other. In this example (0, π) is orthogonal to (π/2, 3π/2), but any orthogonal pairing will provide the same result.

### Use Case Example

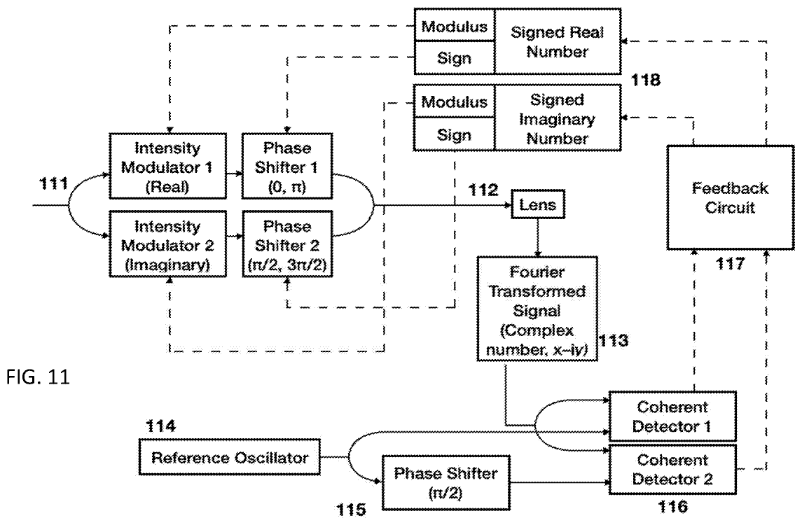

An example of achieving the multiplication follows. Referring to FIG. 11, which describes the optical and electrical path for one pixel Coherent light enters at 111 into the amplitude and phase modulator. On the first pass, the modulators are passive. The light is then passed through a lens 112 in unison with light from all other pixels. The lens performs an optical Fourier Transform (FT). The light is collected at the Fourier plane (equal to the focal length of the lens) at 113, and brought to a pair of Multi Mode Interferometers (MMIs) 116. Simultaneously, the reference light entering at 114 is split and passed to the coherent detector (MMI and balance photo-detectors) with one path travelling via a π/2 phase shifter 115. The coherent detectors interfere the Fourier Transformed signal with the reference oscillator signal, with one being in-phase, and the other in-quadrature.

The currents from the coherent photo-detector are amplified and converted to voltages. The voltage from each balanced PD pair is produced, ΔV_{PD}=V_{PD}_{₁}−V_{PD}_{₂}. The absolute sum of the currents is used to derive the drive signal for the intensity modulator branch. The polarity of the difference signal ΔV_{PD} is related to the phase of the light relative to the RO. This information is passed to the Feedback circuit 117 used to drive the magnitude and sign of the intensity and phase modulators 118.

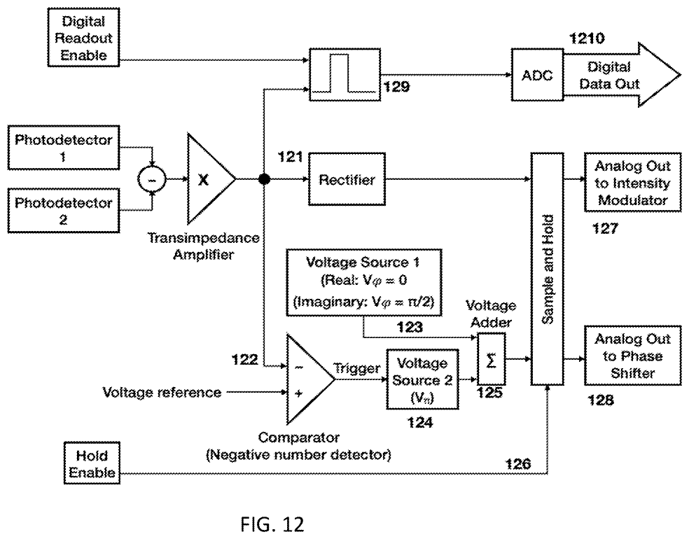

FIG. 12 shows an example of the analog circuit which processes the signal from each pair of balanced PDs and produces appropriate drive signals for the intensity and phase modulators. The difference signal ΔV_{PD} from a transimpedance amplifier fed into three circuits for rectification 121, sign detection 122 and for digital conversion 129.

The rectified output is used to determine the magnitude of the drive required for intensity and phase modulators.

The sign detection circuit 122 uses a comparator to compare the difference signal with a predetermined voltage reference to detect negative voltage. The output from the comparator is used to trigger a voltage source provides a voltage (V) or 0 otherwise 124, and in combination with a second voltage source 123 generates bias required to obtain a phase shift of (0, π) in the phase shifter of the Intensity modulator, or (π/2, 3π/2) in the phase shifter of the Phase modulator. The output from the triggered voltage source V is added with the fixed voltage generated at 125. The fixed voltage adjusts for fine calibrations. A sample and hold circuit 126 is triggered to hold the voltage levels generated by the rectifier and phase detector circuits. When the system is ready for the next frame, the outputs of the sample and hold are sent to the modulators 127 and 128.

A readout signal from digital backend enables digital conversion 129 of the difference signal using an analog-to-digital convertor, providing digital data 1210 for processing.

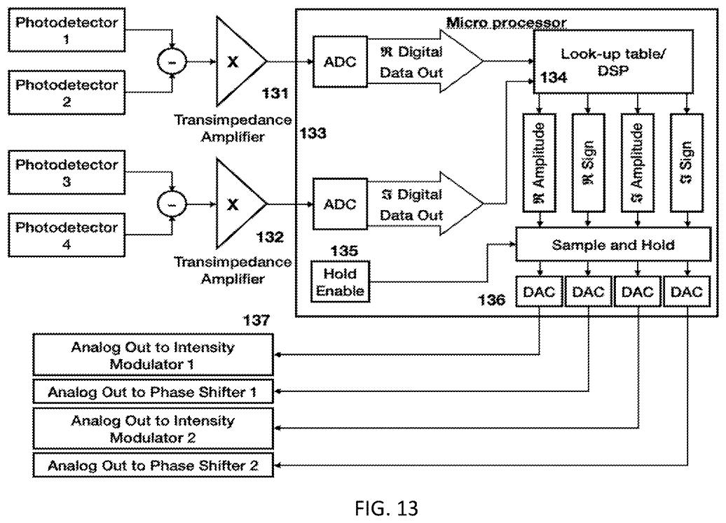

FIG. 13 describes a digital method of performing the Cartesian addressing method. The balanced photodetector difference signals are amplified by amplifier 131 and 132 and fed into high-speed Analog-to-Digital Converters (ADCs) 133. A microprocessor receives the digital information and addresses a pre-calibrated look-up-table (LUT) or Digital Signal Processor 134 to retrieve the necessary digital values to pass to a set of Digital-to-Analog Converters (DACs) 136 which generate the correct voltage or current to drive the intensity and phase modulators 137. The circuit uses a sample and hold trigger 135 which holds the digital signal constant or renews the value at the desired time. The amplitude and phase modulation then acts as the optical multiplication stage for the subsequent input optical signals. The readout of the result is achieved by using the same ADCs and microprocessor which can process the data directly, or pass the data to a host PC for processing.

### Pre-Calibration of the Phase of the Optical Device

The previously described optical systems and others require calibration. In particular, problems arise with the calibration of the input pixels of an optical computing device which, in certain embodiments, may be overcome. Embodiments of the invention may focus in particular on their relative phase. The main difficulty is that commonly-used PDs measure only the light intensity, losing all information on the phase of the (complex) amplitude of the electro-magnetic field. The two methods described below use the properties of the Fourier transform to circumvent this difficulty. Each one of the previously described embodiments may be configured to be suitable for these calibration or pre-calibration methodologies.

In a broad sense, an optical device made of three elements:
A mechanism to set the complex amplitude of the field at different points of an “input” plane, with tunable parameters to change the amplitude independently at each point.
A lens or other optical system producing the Fourier transform in a different plane, called the “output” plane.
A system to measure the light intensity at different points of the output plane, with positions chosen so as to approximate a discrete Fourier transform.

The two techniques presented here may be used as a first step for more involved and accurate calibration procedures using for instance a machine-learning approach. For this reason, it may be appropriate to refer to them as “pre-calibration”. In practice, however, they provide relatively good results on embodiments of the invention, with a total runtime of the order of one hour.

Furthermore, a procedure is provided which can be used to recover the complex Fourier transform from its squared absolute value. This assumes the input pixels have already been calibrated.

In this section, it is assumed for definiteness that the pixel corresponding to the DC term in Fourier space is the central one. The discussion equally applies to the case where the Fourier plane is centred differently, up to the replacement of “central pixel” by the corresponding one.

### Estimating the Phase Difference Using the Central Pixel

A method which estimates the relative phase between two input pixels consists in measuring the value of the central pixel in Fourier space for three configurations, and combining the results to get the cosine of the phase difference. It is justified by the two properties: the central value of the optical Fourier transform is proportional to the sum of the input values, and a photo-detector placed in the focal plane of the optical device measures the light intensity, proportional to the squared absolute value of the Fourier transform of the input.

In certain embodiments, the parameters of the modulators can be tuned so that each pixel is set independently in one of the two states “off”, where it has a value 0, and “on”, where it has a non-vanishing (but possibly unknown) value. In certain embodiments, neither state has a value of 0. Further embodiments of the invention therefore envisage a first level and a second level provided these are predetermined levels for each set of the calibration process.

Considering two pixels, denoted by a and b, the device is first used three times with three different inputs and is configured to measure the value of the central pixel of the output:
once with the input pixel a on and all other input pixels off; the value of the central output pixel may be called Iₐ;
once with the input pixel b on and all other input pixels off; the value of the central output pixel may be called I_{b};
once with the input pixels a and b on and all other input pixels off; the value of the central output pixel may be called I_{a,b}.

The phase difference between two pixels labeled by a and b in their “on” state can then be estimated using the formula:

$$cos ( {ϕ}_{a , b} ) = \frac{{I}_{a , b} - {I}_{a} - {I}_{b}}{2 \sqrt{{I}_{a} {I}_{b}}} \qquad Equation 3$$

Inverting the cosine function then yields the value of the phase difference up to a sign. This sign ambiguity can be resolved by measuring the phase differences of a and b with another pixel if the input plane has N pixels, performing this operation N times yields the phases of each pixel up to a global additive constant and an overall sign. This remaining sign ambiguity can be lifted by measuring the value of another output pixel when two input pixels are in their “on” state.

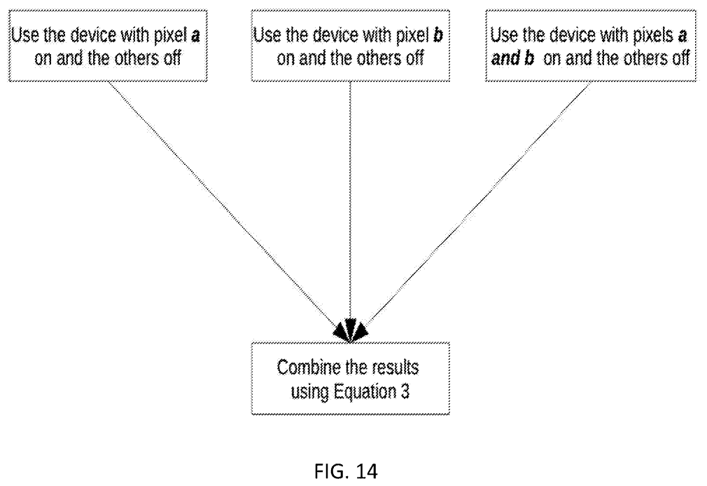

FIG. 14 shows a flow diagram of this process.

While this method is particularly fast and easy to implement, it suffers from some limitations:

It assumes that the operation performed by the optical device is close to a discrete Fourier transform. Deviations, through imperfections or other parasite effects, or misalignment of the device used to measure the output, can reduce its accuracy.

Since it relies on the value of one output pixel only, it is more sensitive to noise than methods using the full output plane. It is also more sensitive to defects which may affect this pixel predominantly.

It does not directly provide the sign of the phase difference between two pixels. As was mentioned above, some information on the sign can be recovered by performing it several times with different pixels. The signs can in principle be recovered by performing the measurement once with a chosen reference pixel, interfered in-turn with each other pixel, then repeating the measurement with a different reference pixel. In essence, this provides all the phase information for every possible pair of pixels. However, this is only possible if the errors are small enough.

It does not directly provide information on how to tune the parameters to produce inputs with other phases.

### Estimating Parameter Values Yielding a Specific Phase and Amplitude

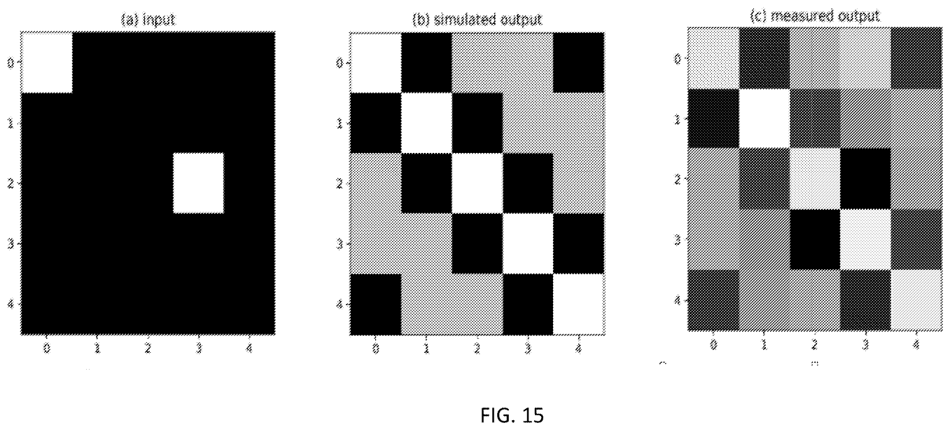

A method to set the relative amplitude and phase difference of the input pixels is also described which may have applications in any of the previous embodiments and many other optical systems of the kind in question. In one embodiment, it is assumed that the value of each input pixel is determined by some parameters (e.g two modulator values) independently of the other pixels. (This method can be applied in the case where the pixel values are not strictly independent, but the accuracy will be reduced.) It proceeds in the following way:
Choose an input pixel r to serve as reference and find parameters for which it has a relatively high value.
Define a distance between two images, for instance the “pseudo-Euclidean distance” defined below.
For each other pixel p,
   select a desired phase difference ϕₚ and relative modulus aₚ with the reference pixel. Select many different values, denoted by v in the following, of the parameters for pixel p. Set all input pixels to their “off” state except r and p. An example is shown in FIG. 15a.
   Store the output image, called

Oₚ(v)
in the following.
Compute the squared absolute value of the discrete Fourier transform of the input obtained by setting all the pixels to 0 except the reference pixel, with value 1, and pixel p, with value

$${a}_{p} \cdot {e}^{i {ϕ}_{p}}$$

An example output is shown in FIG. 15c with a simulated output shown in FIG. 15b for comparison. Store the result, called

Tₚ
in the following.
Find the values v of the parameters for which the distance between Oₚ(v) and

Tₚ
is smallest. These are the optimal parameter values.

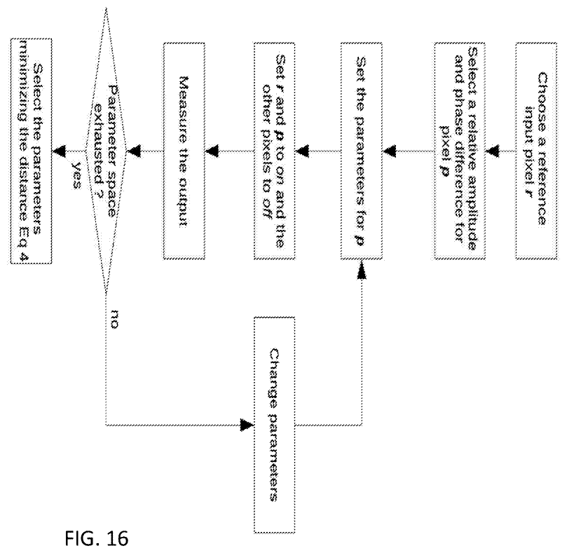

A flow diagram describing this method is shown in FIG. 16.

The pseudo-Euclidean distance between images may be used, defined as follows. Let A and B be two images whose pixels have non-negative real values, with pixels labeled by elements of some set P. (For instance, P may be the set of integers between 1 and the number of pixels of each image included.) In one embodiment, it is assumed that they each have at least one non-vanishing pixel. The pseudo-Euclidean distance between A and B may be defined as:

$${E}_{A , B} = \sqrt{{\sum }_{p ∈ P} {( \frac{{A}_{p}}{max ( A )} - \frac{{B}_{p}}{max ( B )} )}^{2}} \qquad Equation 4$$

(It would be an actual Euclidean distance without the division by the maximum values.)

If N denotes the number of pixels in the input and m the number of parameters values tried for each pixel, this method requires computing (N−1)m outputs from the optical device and (N−1)m pseudo-Euclidean distances between images. As mentioned above, it assumes that the pixel values can be set independently; co-dependence of different pixel values on some of the parameters will reduce its accuracy. However, making use of all output pixels, it is, in certain embodiments, less sensitive to noise and to imperfections which may predominantly affect one or a few pixels.

### Recovering the Complex Fourier Transform

The photodetectors employed in certain embodiments measure the squared absolute value of the amplitude of the electro-magnetic field. In this section, a procedure used to recover the complex Fourier transform of the input is disclosed.

It relies on the fact that the Fourier transform (denoted by F in the following) is a linear operation. Using this property, one can show that the Fourier transforms of two arrays X and Y and their sum with or without a factor i are related by:

$$ℛ ( F ( X ) ) = \frac{1}{2 F ( Y ) *} ( {\vert F ( X + Y ) \vert}^{2} - {\vert F ( X ) \vert}^{2} - {\vert F ( Y ) \vert}^{2} )$$

$$and$$

$$𝒥 ( F ( X ) ) = \frac{1}{2 F ( Y ) *} ( {\vert F ( X + iY ) \vert}^{2} - {\vert F ( X ) \vert}^{2} - {\vert F ( Y ) \vert}^{2} )$$

The complex Fourier transform of an array X can thus be computed using an optical device which outputs its squared modulus in the following way:
Choose an array Y whose Fourier transform F(Y) has already been computed (possibly using a different system) or is known analytically, and such that no coefficient of F(Y) vanishes. (In practice, the array with all coefficients set to 0 except the top-left one, equal to 1 is chosen for Y.)
Use the optical device three times: once with input X, yielding |F(X)|², once with input X+Y, yielding |F(X+Y)|², and once with input X+iY, yielding |F(X+iY)|². (In practice, these three outputs may need to be rescaled.)
Combine the results to obtain the real and imaginary parts of F(X) using the above equations. The full complex Fourier transform is then equal to: F(X)= [symbol] (F(X))+i [symbol] F(X))

1. An optical processing system comprising an optical input; an optical Fourier transform stage; at least one modulator provided between said optical input and said optical Fourier transform stage; and said optical Fourier transform stage providing an optical output to at least one photodetector for receiving a reference optical signal to provide currents and/or voltages relating to the intensities and/or phases of said reference optical signal; said system further comprising an electronics feedback loop which feeds back said currents and/or voltages and causes said modulators to modulate the intensities and/or phases of a subsequent optical signal.

2. The optical processing system according to claim 1, wherein said Optical Fourier transform stage is a single Optical Fourier transform stage.

3. The optical processing system according to claim 1, wherein at least one modulator comprises an interferometer with a first branch for optically encoding a signed Real value and with a second branch for optically encoding a signed Imaginary value.

4. The optical processing system according to claim 3, wherein said interferometer encodes a signed magnitude and a signed orthogonal or quadrature phases on said optical signal.

5. The optical processing system according to claim 1, further comprising as part of said electronics feedback loop an analogue circuit configured to carry out a mathematical function on currents from said photodetectors to provide an output of currents and/or voltages which is proportional to the phase of said reference optical signal.

6. The optical processing system according to claim 5, wherein said analogue circuit comprises at least one pair of photodetectors.

7. The optical processing system according to claim 1, wherein said electronics feedback loop comprises at least one driver for intensity and/or phase modulation.

8. The optical processing system according to claim 7, wherein said analogue circuit comprises a rectifier circuit which drives intensity modulation.

9. The optical processing system according to claim 7, wherein said analogue circuit comprises a comparator to compare the difference signal with a predetermined voltage reference.

10. The optical processing system according to claim 9, wherein said comparator has an output and said analogue circuit takes said comparator output and adds another predetermined voltage; whereby a phase shift is generated for phase shifting modulation.

11. The optical processing system according to claim 1, comprising at least one pair of photodetectors, at least one analogue to digital converter, a microprocessor with either a pre-calibrated look-up-table to retrieve digital values or a digital signal processor (DSP), and at least one digital to analogue converter which generate the voltages and/or currents for driving intensity and/or phase modulators which modulate the intensities and/or phases of said optical signal.

12. A method of optical processing comprising the steps of providing an optical input, providing an optical Fourier transform stage; providing at least one modulator between said optical input and said optical Fourier transform stage; and said optical Fourier transform stage providing an optical output to at least one photodetector for receiving a reference optical signal to provide currents and/or voltages relating to the intensities and/or phases of said reference optical signal; providing an electronics feedback loop; feeding back said currents and/or voltages; and modulating the intensities and/or phases of a subsequent optical signal.

13. The method according to claim 12, wherein said Optical Fourier transform stage is a single Optical Fourier transform stage.

14. The method according to claim 12, further comprising the step of optically encoding a signed Real value and a signed Imaginary value into the properties of said optical signal.

15. The method according to claim 12, further comprising the steps of encoding a signed magnitude and a signed orthogonal or quadrature phases on said optical signal.

16. The method according to claim 12, further comprising the step of providing, as part of said electronics feedback loop, an analogue circuit; and carrying out a mathematical function on currents from said photodetector to provide an output of currents and/or voltages which is proportional to the phase of said reference optical signal.

17. The method according to claim 16, wherein said analogue circuit comprises at least one pair of photodetectors.

18. The method according to claim 12, wherein said electronics feedback loop comprises at least one driver for intensity and/or phase modulation.

19. The method according to claim 18, wherein said analogue circuit comprises a rectifier circuit which drives intensity modulation.

20. The method according to claim 18, wherein said analogue circuit comprises a comparator; and said method comprises the further step of comparing the difference signal with a predetermined voltage reference.

21. The method according to claim 20, wherein said comparator has an output and said method comprises the steps of taking said comparator output and adding another predetermined voltage; whereby a phase shift is generated for phase shifting modulation.

22. The method according to claim 12, comprising the steps of providing at least one pair of photodetectors, providing a microprocessor, providing at least one analogue to digital converter, providing either a pre-calibrated look-up-table or a digital signal processor (DSP) to retrieve digital values, and providing at least one digital to analogue converter which generate the voltages and/or currents for driving intensity and/or phase modulators which modulate the intensities and/or phases of said optical signal.

23. A method of calibrating an optical processing system comprising the steps of:
providing an input plane with a plurality of independently tuneable pixels; and an optical system for producing an Optical Fourier transform in an output plane;
measuring the light intensity at different pixels of said output plane;
selecting a first pixel of said output plane; and
comparing the intensity of a further pixel a with that obtained with said first pixel.

24. The method of calibrating an optical processing system according to claim 23, comprising the further steps of:
selecting level 1 and level 2 as predetermined fixed levels;
selecting said pixel a and a further pixel b;
measuring a value of said output corresponding to said first pixel in at least the following modes: with pixel a at level 1 and all other input pixels at level 2; with pixel b at level 1 and all other input pixels at level 2; and with pixels a and b at level 1 and all other input pixels at level 2; and
estimating a phase difference between said pixels a and b in their level 1 state.

25. The method according to claim 23, wherein said first pixel corresponds to an arbitrary pixel in the input function.

26. The method according to claim 25, wherein said first pixel corresponds to the central pixel in the input function.

27. The method according to claim 24, comprising the further step of measuring the phase differences of a and b with a further pixel.

28. A method of calibrating an optical processing system comprising the steps of providing an input plane with a plurality of independently tuneable pixels; and an optical system for producing an Optical Fourier transform in an output plane; measuring the light intensity at different pixels of said output plane; and comparing an output with theoretical predictions and minimizing the distance between them over predetermined input parameters.

29. The method according to claim 28, wherein said step of minimizing is performed by successively setting the input parameters to each of their possible values, recording the corresponding outputs, then computing the distance for each value and selecting the one giving the minimum distance.

30. The method according to claim 28, further comprising the step of computing said distance on an external electronic computing device.

31. The method according to claim 28, further comprising the step of successively performing calibration on each of the input pixels after the choice of a reference pixel.

32. The method according to claim 28, wherein the distance is defined by taking the squared absolute value of the output from the optical system and computing the Euclidean distance from the theoretical prediction after dividing each of them by their maximum value.

33. The method according to claim 28, wherein the minimization proceeds as follows:
selecting an input pixel r to serve as reference;
finding parameters for which r has a relatively high value;
for at least one other pixel p, selecting a desired phase difference p and relative modulus a with said reference pixel;
selecting values, denoted by v of the parameters for pixel p;
setting all input pixels to 0 except r and p;
storing the resulting output image, called O(v) hereafter;
computing the squared absolute value of the discrete Fourier transform of the input obtained by setting all the pixels to 0 except the reference pixel, with value 1, and pixel p, with value given by the formula a exp(i φ);
storing the result, called T; and
finding the values v of the parameters for which the distance between O(v) and T is smallest.
